(19) United States
(12) Patent Application Publication
(10) Pub. No.: US 2022/0332331 A1
(43) Pub. Date: Oct. 20, 2022

(54) REDUNDANCY STRUCTURE FOR AUTONOMOUS DRIVING SYSTEM

(71) Applicant: BEIJING VOYAGER TECHNOLOGY CO., LTD., Beijing (CN)

(72) Inventors: Tingyou MING, Hangzhou (CN); Xiaowei CHEN, Beijing (CN); Xiaofeng HUANG, Beijing (CN); Jiangyuan SUN, Beijing (CN); Wenchang WU, Mountain View, CA (US); Xiaocheng ZHANG, Mountain View, CA (US)

(73) Assignee: BEIJING VOYAGER TECHNOLOGY CO., LTD., Beijing (CN)

(21) Appl. No.: 17/753,480

(22) PCT Filed: Sep. 3, 2019
(86) PCT No.: PCT/CN2019/104224

§ 371 Date: Mar. 3, 2022

(51) Int. Cl. B60W 50/023; B60W 10/18; B60W 10/20; B60R 16/033

(52) U.S. Cl. CPC B60W 50/023; B60W 10/18; B60W 10/20; B60R 16/033; B60W 60/001

(57) ABSTRACT

The present disclosure provides a system of a redundancy structure for an autonomous driving system. The system may comprise an acquisition sub-system, a power supply sub-system and a processing sub-system connecting the acquisition sub-system. The acquisition sub-system may include at least one primary acquisition device and at least one backup acquisition device. The power supply sub-system may include a primary power supply device configured to power the at least one primary acquisition device and a first portion of the at least one backup acquisition device, and a backup power supply device configured to power the at least one primary acquisition device and a second portion of the at least one backup acquisition device. The processing sub-system may include a primary processing device, and a backup processing device that serves as a backup device of at least a part of the primary processing device.

### TECHNICAL FIELD

The present disclosure generally relates to an autonomous driving system, and in particular, to a redundancy structure in an autonomous driving system.

### BACKGROUND

With the development of micro-electronic and robotic technologies, the exploration of autonomous driving has developed rapidly. Commonly, an autonomous driving system of a vehicle can obtain driving information (e.g., velocity, acceleration) associated with traffic information (e.g., existence of objects within a predetermined distance range of the vehicle), process the driving information associated with the traffic information, and plan a driving path for the vehicle based on the processing results. Since the autonomous driving system needs rapid calculation and prompt reaction to ensure safety, it is crucial to ensure stability and efficiency of the autonomous driving system. Therefore, it is desirable to provide an autonomous driving system with a redundancy structure so as to improve stability and efficiency of the system.

### SUMMARY

In an aspect of the present disclosure, a system of a redundancy structure for an autonomous driving system is provided. The system may comprise an acquisition sub-system, a power supply sub-system and a processing sub-system connecting the acquisition sub-system. The acquisition sub-system may include at least one primary acquisition device and at least one backup acquisition device. The power supply sub-system may include a primary power supply device configured to power the at least one primary acquisition device and a first portion of the at least one backup acquisition device, and a backup power supply device configured to power the at least one primary acquisition device and a second portion of the at least one backup acquisition device. The processing sub-system may include a primary processing device powered by both the primary power supply device and the backup power supply device, and a backup processing device that serves as a backup device of at least a part of the primary processing device. The backup processing device may be powered by both the primary power supply device and the backup power supply device.

In some embodiments, the system may further include a control sub-system. The control sub-system may include one or more primary control devices and one or more backup control devices. Each of the one or more primary control devices may have at least one of the one or more backup control device serving as a backup device of the primary control device.

In some embodiments, the primary control devices may include a powertrain device, a primary braking device, and a primary steering device. The backup control devices may include a backup braking device and a backup steering device.

In some embodiments, the control sub-system may be powered by both the primary power supply device and the backup power supply device.

In some embodiments, the system may further include a primary gateway connecting the primary processing device and the backup processing device with the control sub-system, and a backup gateway connecting the primary processing device and the backup processing device with the control sub-system.

In some embodiments, the system may further include a communication sub-system. The communication sub-system may include a first interface connecting the primary processing device and the backup processing device to the primary gateway, and a second interface being a backup interface of the first interface. The second interface may connect the primary processing device and the backup processing device to the backup gateway.

In some embodiments, the system may further include a third interface connecting the primary gateway with the control sub-system, and a fourth interface being a backup interface of the third interface. The fourth interface may connect the backup gateway with the control sub-system.

In some embodiments, the system may be an autonomous driving system.

In some embodiments, the at least one primary acquisition device may include a LIDAR. The at least one backup acquisition device may include a camera, a radar, an ultrasonic radar, or a vehicle-to everything (V2X).

In some embodiments, the at least one backup acquisition device may include two sensors of a same type. The two sensors may be powered by the primary power supply device and the backup power supply device, respectively.

In some embodiments, the primary processing device may include a plurality of sensor processors and a primary planning and control processor. The backup processing device may include a backup planning and control processor. The backup planning and control processor may be a backup device of the primary planning and control processor.

In some embodiments, the primary power supply device and the backup power supply device may include batteries independent to each other.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary vehicle with an autonomous driving capability according to some embodiments of the present disclosure;

FIG. 1B is a schematic diagram illustrating an exemplary vehicle with an autonomous driving capability according to some embodiments of the present disclosure;

FIG. 2 is a schematic diagram illustrating exemplary hardware and/or software components of an exemplary computing device according to some embodiments of the present disclosure;

FIG. 3 is a block diagram illustrating exemplary sub-systems of an autonomous driving system according to some embodiments of the present disclosure;

FIG. 4 is a block diagram illustrating an exemplary acquisition sub-system according to some embodiments of the present disclosure;

FIG. 5 is a block diagram illustrating an exemplary power supply sub-system according to some embodiments of the present disclosure;

FIG. 6 is a block diagram illustrating an exemplary processing sub-system according to some embodiments of the present disclosure;

FIG. 7 is a block diagram illustrating an exemplary control sub-system according to some embodiments of the present disclosure; and

FIG. 8 is a schematic diagram illustrating an exemplary redundancy structure of an autonomous driving system according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, operations, elements, and/or components, but do not preclude the presence or addition of one or more other features, integers, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

Moreover, while the systengine management module and methods disclosed in the present disclosure are described primarily regarding a ground transportation system, it should be understood that this is only one exemplary embodiment. The system of the present disclosure may be applied to any other kind of transportation system. For example, the system of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to a redundancy structure for an autonomous driving system. According to the system of the present disclosure, the autonomous driving system may include an acquisition sub-system, a power supply sub-system, a processing sub-system, a control sub-system, and a communication sub-system. A sub-system may have a redundancy structure to avoid accidents caused by errors of the autonomous driving system due to failures of one or more components or devices of any one of the acquisition sub-system, power supply sub-system, processing sub-system, control sub-system, and communication sub-system. According to the system of the present disclosure, the redundancy structure of the acquisition sub-system, power supply sub-system, processing sub-system, control sub-system, and communication sub-system may ensure that the autonomous driving system has higher stability and efficiency, thereby improving the reliability and safety of an autonomous driving vehicle.

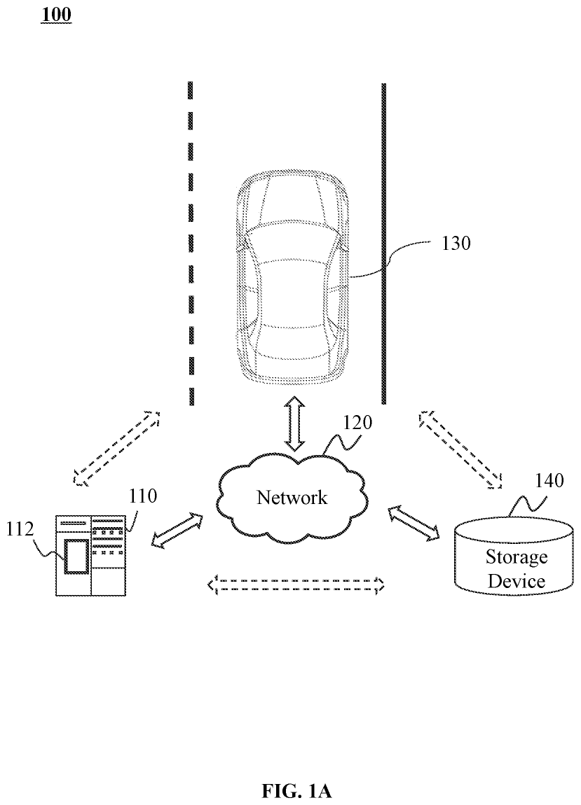

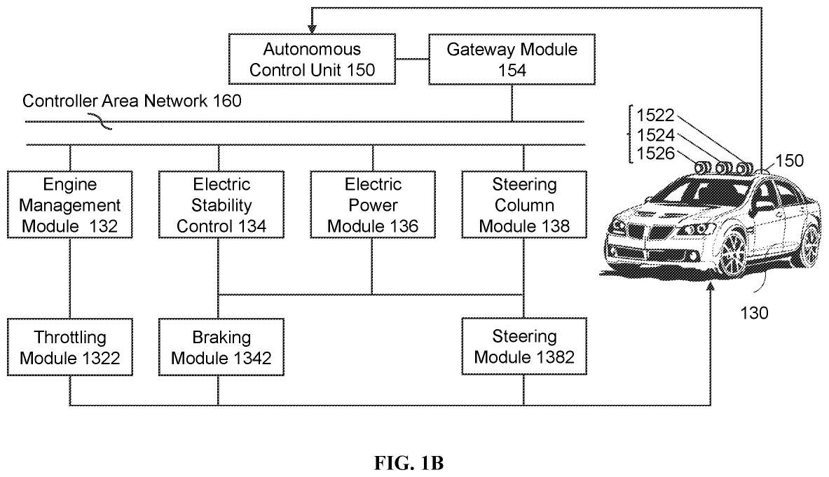

FIG. 1A is a schematic diagram illustrating an exemplary vehicle with an autonomous driving capability according to some embodiments of the present disclosure. In some embodiments, the vehicle 130 may connect to a processing device 110 and a storage device 140 via a network 120. In some embodiments, the processing device 110 and/or the storage device 140 may be installed on the vehicle 130 as indicated by the bidirectional dotted arrows in FIG. 1A. In some embodiments, the vehicle 130 may include a processing device and/or a storage device on board, and also be connected to a processing device and/or a storage device via the network 120.

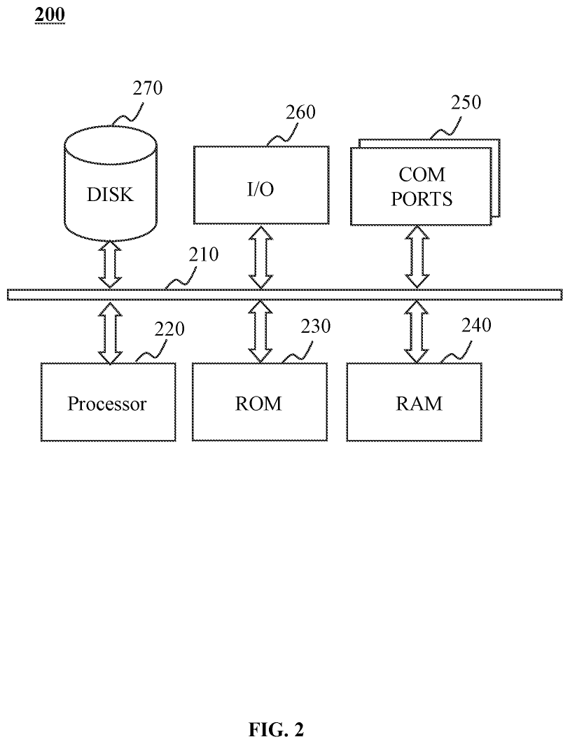

In some embodiments, the processing device 110 may be a single server or a server group. The server group may be centralized or distributed (e.g., the processing device 110 may be a distributed system). In some embodiments, the server 110 may be local or remote. For example, the processing device 110 may access information and/or data stored in the vehicle 130 and/or the storage device 140 via the network 120. As another example, the processing device 110 may be directly connected to the vehicle 130 and/or the storage device 140 to access stored information and/or data. In some embodiments, the processing device 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 110 may be implemented on a computing device 200 including one or more components illustrated in FIG. 2 in the present disclosure.

In some embodiments, the processing device 110 may process information and/or data associated with driving information associated with the vehicle 130 to perform one or more functions related to the autonomous driving. In some embodiments, the processing device 110 may include an autonomous control unit, and a plurality of sensors. The autonomous control unit may output a plurality of control signals. For example, the autonomous control unit may determine a plurality of control signals for the vehicle 130 based on the environmental information and driving mode of the vehicle 130. The plurality of control signals may be configured to be received by a plurality of electronic control units (ECUs) to control the drive of the vehicle 130.

In some embodiments, the processing apparatus 112 may include one or more processing engines (e.g., single-core processing engine(s) or multi-core processor(s)). Merely by way of example, the processing apparatus 112 may include various types of processing devices including a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing apparatus 112 may include at least one backup processing device that serves as a backup device of at least one primary processing device.

In some embodiments, the processing device 110 may be connected to the network 120 to communicate with one or more components (e.g., the vehicle 130, the storage device 140) of the autonomous driving system 100. In some embodiments, the processing device 110 may be directly connected to or communicate with one or more components (e.g., the vehicle 130, the storage device 140) of the autonomous driving system 100. In some embodiments, the processing device 110 may be integrated into the vehicle 130. For example, the processing device 110 may be a computing device (e.g., an on-board computer) installed in the vehicle 130.

The network 120 may facilitate the exchange of information and/or data. In some embodiments, one or more components (e.g., the processing device 110, the vehicle 130, or the storage device 140) of the autonomous driving system 100 may send information and/or data to other component(s) of the autonomous driving system 100 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the autonomous driving system 100 may be connected to the network 120 to exchange data and/or information.

The vehicle 130 may be an autonomous vehicle of any type. The autonomous vehicle may be capable of sensing environmental information and navigating without human intervention. The vehicle 130 may include structures and/or components of a conventional vehicle. For example, the vehicle 130 may include a plurality of control components configured to control operations of the vehicle 130. The plurality of control components may include a steering device (e.g., a steering wheel), a brake device (e.g., a brake pedal), an accelerator, etc. The steering device may be configured to adjust a heading angle and/or a direction of the vehicle 130. The braking device may be configured to perform a braking operation to slow down or stop the vehicle 130. The accelerator may be configured to control a velocity and/or an acceleration of the vehicle 130.

The vehicle 130 may also include a plurality of acquisition devices configured to acquire environmental information associated with the vehicle 130. The plurality of acquisition devices may include a group of distance sensor (e.g., one or more LIDARs, one or more radars, one or more infrared sensors, one or more ultrasonic devices), a group of cameras, a global position system (GPS) module, a vehicle-to-everything (V2X), etc. In some embodiments, the plurality of acquisition devices may also be configured to acquire driving information of the vehicle 130. For example, the plurality of acquisition devices may include a group of acceleration sensor (e.g., one or more piezoelectric sensors), a group of velocity sensor (e.g., one or more Hall sensor), a group of steering angle sensors (e.g., one or more tilt sensor), a group pf traction-related sensors (e.g., one or more force sensor), etc. In some embodiments, the environmental information associated with the vehicle 130 may include information of a plurality of objects (e.g., a pedestrian, a vehicle) on a traveling path of the vehicle 130. In some embodiments, the environmental information associated with the vehicle 130 may further include a road condition and/or map information.

The storage device 140 may store data and/or instructions. In some embodiments, the storage device 140 may store data obtained from the vehicle 130, such as environmental information and/or driving information associated with the vehicle 130 acquired by the plurality of acquisition devices. In some embodiments, the storage device 140 may store data and/or instructions that the processing device 110 may execute or use to perform exemplary operations associated with autonomous driving. In some embodiments, the storage device 140 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components (e.g., the processing device 110, the vehicle 130) of the autonomous driving system 100. One or more components of the autonomous driving system 100 may access the data or instructions stored in the storage device 140 via the network 120. In some embodiments, the storage device 140 may be directly connected to or communicate with one or more components (e.g., the processing device 110, the vehicle 130) of the autonomous driving system 100. In some embodiments, the storage device 140 may be part of the processing device 110. In some embodiments, the storage device 140 may be integrated into the vehicle 130.

It should be noted that the autonomous driving system 100 is merely provided for the purposes of illustration, and is not intended to limit the scope of the present disclosure. For persons having ordinary skills in the art, multiple variations or modifications may be made under the teachings of the present disclosure. For example, the autonomous driving system 100 may further include a database, an information source, etc. As another example, the autonomous driving system 100 may be implemented on other devices to realize similar or different functions. However, those variations and modifications do not depart from the scope of the present disclosure.

FIG. 1B is a schematic diagram illustrating an exemplary vehicle with an autonomous driving capability according to some embodiments of the present disclosure. For example, the autonomous driving system 100 may at least include a vehicle platform and an autonomous platform, and the vehicle 130 may drive autonomously, or drive under human control.

The vehicle platform may be configured to drive the vehicle 130 with or without human maneuver. For example, the vehicle platform may include an engine management module 132, an electric stability control (ESC) 134, an electric power module 136, a steering column module (SCM) 138, a throttling module 1322, a braking module 1342, and a steering module 1382.

The autonomous platform may process information and/or data relating to vehicle driving (e.g., autonomous driving) to perform one or more functions described in the present disclosure. In some embodiments, the autonomous platform may be configured to drive the vehicle 130 autonomously. In some embodiments, the autonomous platform may include an autonomous control unit 150, and a plurality of sensors 1522, 1524, 1526. The autonomous control unit 150 may output a plurality of control signals. For example, the autonomous control unit 150 may determine a plurality of control signals for the vehicle 130 based on the environmental information and driving mode of the vehicle 130. The plurality of control signals may be configured to be received by a plurality of electronic control units (ECUs) to control the drive of the vehicle 130.

The plurality of sensors (e.g., a plurality of sensors 1522, 1524, 1526) may be configured to provide information that is used to control the vehicle 130. In some embodiments, the sensors may sense the status of the vehicle 130. The status of the vehicle 130 may include the real-time operation condition of the vehicle 130, environmental information around the vehicle 130, or the like, or any combination thereof. In some embodiments, the plurality of sensors may be set on the body of the vehicle 130 (e.g., a front bumper, a car roof).

Merely by way of example, the plurality of sensors may include a group of distance sensors, a group of velocity sensors, a group of acceleration sensors, a group of steering angle sensors, a group of traction-related sensors, a group of cameras, and/or any sensors. The group of distance sensors (e.g., one or more radars, one or more LIDARs, one or more infrared sensors) may determine a distance between the vehicle 130 and other objects (e.g., an obstacle). The group of distance sensors may also determine a distance between the vehicle 130 and one or more obstacles (e.g., a static obstacle, a moving obstacles). The group of velocity sensors (e.g., one or more Hall effect sensors) may determine a velocity (e.g., an instantaneous velocity, an average velocity) of the vehicle 130. The group of acceleration sensors (e.g., one or more accelerometer) may determine an acceleration (e.g., an instantaneous acceleration, an average acceleration) of the vehicle 130. The group of steering angle sensors (e.g., one or more tilt sensors or one or more micro-gyroscopes) may determine a steering angle of the vehicle 130. The group of traction-related sensors (e.g., one or more force sensor) may determine a traction of the vehicle 130.

As another example, the plurality of sensors may include one or more video cameras, laser-sensing devices, infrared-sensing devices, acoustic-sensing devices, thermal-sensing devices, or the like, or any combination thereof. The plurality of sensors may detect a road geometry and/or obstacles (e.g., static obstacles, moving obstacles). The road geometry may include a road width, road length, road type (e.g., ring road, straight road, one-way road, two-way road). Exemplary static obstacles may include a building, a tree, a roadblock, or the like, or any combination thereof Exemplary moving obstacles may include a moving vehicle, a pedestrian, and/or an animal, or the like, or any combination thereof.

In some embodiments, the autonomous control unit 150 may include one or more processing engines (e.g., single-core processing engine(s) or multi-core processor(s)). Merely by way of example, the autonomous control unit 150 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the autonomous driving system 100 may include a gateway module 154. The gateway module 154 may determine a command source for the plurality of ECUs (e.g., the engine management module 132, the electric power module 136, the ESC 134, and the SCM 138) based on a current driving mode of the vehicle. The command source may be from a human driver, from the autonomous control unit 150, from the processing device 110, or the like, or any combination thereof.

The gateway module 154 may determine a current driving mode of the vehicle. The driving mode of the vehicle 130 may include a manual-driving mode, a semi-autonomous driving mode, an autonomous driving mode, a safe mode, or the like, or any combination thereof. For example, the gateway module 154 may determine the current driving mode of the vehicle 130 to be a manual-driving mode based on an input from a human driver. As another example, the gateway module 154 may determine the current driving mode of the vehicle 130 to be an autonomous driving mode when control signals are output by the autonomous control unit 150. As still another example, the gateway module 154 may determine the current driving mode of the vehicle 130 to be a safe mode when an abnormality (e.g., a signal interruption, a processor crash) occurs.

In some embodiments, the gateway module 154 may transmit operations of the human driver to the plurality of ECUs in response to a determination that the current driving mode of the vehicle 130 is a manual-driving mode. For example, the gateway module 154 may transmit a press operation to the accelerator of the vehicle 130 performed by a human driver to the engine management module 132 in response to a determination that the current driving mode of the vehicle 130 is a manual-driving mode. The gateway module 154 may transmit control signals of the autonomous control unit 150 to the plurality of ECUs in response to a determination that the current driving mode of the vehicle 130 is an autonomous driving mode. For example, the gateway module 154 may transmit a control signal associated with a steering operation to the SCM 138 in response to a determination that the current driving mode of the vehicle 130 is an autonomous driving mode. The gateway module 154 may transmit the operations of the human driver and the control signals of the autonomous control unit 150 to the plurality of ECUs in response to a determination that the current driving mode of the vehicle 130 is a semi-autonomous driving mode. The gateway module 154 may transmit an error signal to the plurality of ECUs in response to a determination that the current driving mode of the vehicle 130 is a safe mode. In some embodiments, when the vehicle 130 is in the autonomous driving mode and receives a driver maneuver, the gateway module 154 may transmit the operation of the human driver to the plurality of ECUs.

In some embodiments, the autonomous driving system 100 may include a Controller Area Network (CAN) 160. The CAN 160 may be a robust vehicle bus standard (e.g., a message-based protocol) allowing microcontrollers (e.g., the autonomous control unit 150) and devices (e.g., the engine management module 132, the electric power module 136, the ESC 134, and/or the SCM 138, etc.) to communicate with each other in applications without a host computer. The CAN 160 may be configured to connect the autonomous control unit 150 with the plurality of ECUs (e.g., the engine management module 132, the electric power module 136, the ESC 134, or the SCM 138).

The engine management module 132 may be configured to determine an engine performance of the vehicle 130. In some embodiments, the engine management module 132 may determine the engine performance of the vehicle 130 based on the control signals from the autonomous control unit 150. For example, the engine management module 132 may determine the engine performance of the vehicle 130 based on a control signal associated with an acceleration from the autonomous control unit 150 when the current driving mode is an autonomous driving mode. In some embodiments, the engine management module 132 may determine the engine performance of the vehicle 130 based on operations of a human driver. For example, the engine management module 132 may determine the engine performance of the vehicle 130 based on a press on the accelerator done by the human driver when the current driving mode is a manual-driving mode.

The engine management module 132 may include a plurality of sensors and at least one microprocessor. The plurality of sensors may be configured to detect one or more physical signals and convert the one or more physical signals to electrical signals for processing. In some embodiments, the plurality of sensors may include a variety of temperature sensors, an air flow sensor, a throttle position sensor, a pump pressure sensor, a speed sensor, an oxygen sensor, a load sensor, a knock sensor, or the like, or any combination thereof. The one or more physical signals may include, but not limited to, an engine temperature, an engine intake air volume, a cooling water temperature, an engine speed, or the like, or any combination thereof. The microprocessor may determine the engine performance based on a plurality of engine control parameters. The microprocessor may determine the plurality of engine control parameters based on the plurality of electrical signals. The plurality of engine control parameters may be determined to optimize the engine performance. The plurality of engine control parameters may include an ignition timing, a fuel delivery, an idle air flow, or the like, or any combination thereof.

The throttling module 1322 may be configured to change motions of the vehicle 130. For example, the throttling module 1322 may determine a velocity of the vehicle 130 based on an engine output. For another example, the throttling module 1322 may cause an acceleration of the vehicle 130 based on the engine output. The throttling module 1322 may include fuel injectors, a fuel pressure regulator, an auxiliary air valve, a temperature switch, a throttle, an idling speed motor, a fault indicator, ignition coils, relays, or the like, or any combination thereof.

In some embodiments, the throttling module 1322 may be an external executor of the engine management module 132. The throttling module 1322 may be configured to control the engine output based on the plurality of engine control parameters determined by the engine management module 132.

The ESC 134 may be configured to improve the stability of the vehicle. The ESC 134 may improve the stability of the vehicle 130 by detecting and reducing loss of traction. In some embodiments, the ESC 134 may control operations of the braking module 1342 to help steer the vehicle 130 in response to a determination that a loss of steering control is detected by the ESC 134. For example, the ESC 134 may improve the stability of the vehicle 130 when the vehicle 130 starts on an uphill slope by braking. In some embodiments, the ESC 134 may further control the engine performance to improve the stability of the vehicle. For example, the ESC 134 may reduce an engine power when a probable loss of steering control happens. The loss of steering control may happen when the vehicle 130 skids during an emergency evasive swerve, when the vehicle 130 understeers or oversteers during poorly judged turns on slippery roads, etc.

The braking module 1342 may be configured to control a motion state of the vehicle 130. For example, the braking module 1342 may decelerate the vehicle 130. As another example, the braking module 1342 may stop the vehicle 130 in one or more road conditions (e.g., a downhill slope). As still another example, the braking module 1342 may keep the vehicle 130 at a constant velocity when the vehicle 130 travels on a downhill slope.

The braking module 1342 may include a mechanical control component, a hydraulic unit, a power unit (e.g., a vacuum pump), an executing unit, or the like, or any combination thereof. The mechanical control component may include a pedal, a handbrake, etc. The hydraulic unit may include a hydraulic oil, a hydraulic hose, a brake pump, etc. The executing unit may include a brake caliper, a brake pad, a brake disc, etc.

The electric power module 136 may be configured to control the electric power supply of the vehicle 130. The electric power module 136 may supply, transfer, and/or store electric power for the vehicle 130. For example, the electric power module 136 may include one or more batteries and alternators. An alternator may be configured to charge the battery, and the battery may be connected to other parts of the vehicle 130 (e.g., a starter to provide power). In some embodiments, the electric power module 136 may control power supply to the steering module 1382. For example, the electric power module 136 may supply a large amount of electric power to the steering module 1382 to create a large steering torque for the vehicle 130, in response to a determination that the vehicle 130 needs to conduct a sharp turn (e.g., turning a steering wheel all the way to the left or all the way to the right).

The SCM 138 may be configured to control the steering wheel of the vehicle. The SCM 138 may lock/unlock the steering wheel of the vehicle. The SCM 138 may lock/unlock the steering wheel of the vehicle 130 based on a current driving mode of the vehicle 130. For example, the SCM 138 may lock the steering wheel of the vehicle 130 in response to a determination that the current driving mode is an autonomous driving mode. The SCM 138 may further retract a steering column shaft in response to a determination that the current driving mode is an autonomous driving mode. For another example, the SCM 138 may unlock the steering wheel of the vehicle 130 in response to a determination that the current driving mode is a semi-autonomous driving mode, a manual-driving mode, and/or a safe mode.

The SCM 138 may control the steering of the vehicle 130 based on the control signals of the autonomous control unit 150. The control signals may include information related to a turning direction, a turning location, a turning angle, or the like, or any combination thereof.

The steering module 1382 may be configured to steer the vehicle 130. In some embodiments, the steering module 1382 may steer the vehicle 130 based on signals transmitted from the SCM 138. For example, the steering module 1382 may steer the vehicle 130 based on the control signals of the autonomous control unit 150 transmitted from the SCM 138 in response to a determination that the current driving mode is an autonomous driving mode. In some embodiments, the steering module 1382 may steer the vehicle 130 based on operations of a human driver. For example, the steering module 1382 may turn the vehicle 130 to a left direction when the human driver turns the steering wheel to a left direction in response to a determination that the current driving mode is a manual-driving mode.

In some embodiments, the vehicle 130 may include an interface for a driver to interact with the autonomous driving system 100. For example, the interface may display an icon for each of the manual-driving mode, the autonomous driving mode, and the safe mode. The driver may switch a driving mode via the interface through a voice command, text instruction, or pressing an icon corresponding to the driving mode, etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the autonomous driving system 100 may include a transmission system capable of selecting a gear for the vehicle 130. As another example, the autonomous driving system 100 may include an actuator for actuating the autonomous platform.

FIG. 2 is a schematic diagram illustrating exemplary hardware and/or software components of an exemplary computing device according to some embodiments of the present disclosure. In some embodiments, the processing device 110 may be implemented on the computing device 200. For example, the processing apparatus 112 may be implemented on the computing device 200 and configured to perform functions of the processing apparatus 112 disclosed in this disclosure.

The computing device 200 may be used to implement any component of the autonomous driving system 100 of the present disclosure. For example, the processing apparatus 112 of the autonomous driving system 100 may be implemented on the computing device 200, via its hardware, software program, firmware, or a combination thereof. Although only one such computer is shown for convenience, the computer functions associated with the autonomous driving system 100 as described herein may be implemented in a distributed manner on a number of similar platforms to distribute the processing load.

The computing device 200, for example, may include communication (COMM) ports 250 connected to and from a network (e.g., the network 120) connected thereto to facilitate data communications. The computing device 200 may also include at least one processing device (e.g., a processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read only memory (ROM) 230, or a random access memory (RAM) 240, for storing various data files to be processed and/or transmitted by the computing device 200. The computing device 200 may also include program instructions stored in the ROM 230, the RAM 240, and/or another type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is shown in the computing device 200. However, it should be noted that the computing device 200 in the present disclosure may also include multiple processors, and thus operations that are performed by one processor as described in the present disclosure may also be performed by the multiple processors. For example, the computing device 200 may include a primary processor and a backup processor. The primary processor of the computing device 200 executes one or more operations associated with autonomous driving. The backup processor of the computing device 200 may serve as a backup device of the primary processor. When the primary processor has a failure, the backup processor may perform at least a part of the one or more operations associated with autonomous driving instead of the primary processor.

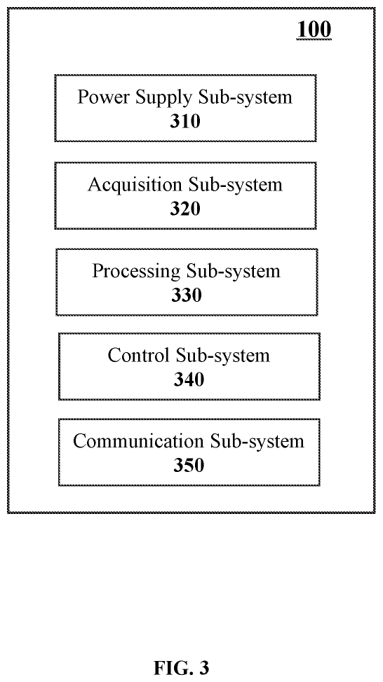

FIG. 3 is a block diagram illustrating exemplary sub-systems of an autonomous driving system according to some embodiments of the present disclosure. The sub-systems of the autonomous driving system 100 may include an acquisition sub-system 320, a power supply sub-system 320, a processing sub-system 330, a control sub-system 340, and a communication sub-system 350. Each sub-system may have a redundancy structure.

The power supply sub-system 320 provide electrical power to the autonomous driving system 100. The power supply sub-system 310 may include a primary power supply device and a backup power supply device. The primary power supply device may be configured to provide electrical power to one or more devices or sub-systems of the autonomous driving system 100. The backup power supply device may be configured to provide electrical power to one or more devices or sub-systems of the autonomous driving system 100. The backup power supply device may be a backup device of the primary power supply device that provides a substitute power supply to the one or more devices or sub-systems of the autonomous driving system 100 when the primary power supply device has a failure (e.g., at a low power). In some embodiments, the primary power supply device may power one or more devices of the acquisition sub-system 320, the processing sub-system 330, and/or the control sub-system 340. In some embodiments, the primary power supply device and/or the backup power supply device may include batteries, such as, a lead acid battery, a lithium battery, a fuel cell battery, etc.

The acquisition sub-system 320 may acquire environmental information associated the vehicle 130. The environmental information may include information of one or more objects on a traveling path of the vehicle 130. As used herein, a traveling path of the vehicle 130 refers to a path the vehicle 130 is projected to take determined based on information including, e.g., driving information, environment information, or the like, or a combination thereof. An object may be any object that may affect the movement, speed, path, and/or safety of the vehicle due to the object's position, movement, size, and/or other features. The object may be static or moving. In some embodiments, the one or more objects may include a vehicle (e.g., a car, a bus, a truck, a motorcycle, a cycle), a pedestrian, an animal, a roadblock, a building, a traffic light, a pedestrian crossing, an intersection, etc. The acquisition sub-system 320 may receive information associated with the one or more objects from a plurality of acquisition devices (e.g., LIDARs, cameras) installed on the vehicle.

In some embodiments, the plurality of acquisition devices may include at least one primary acquisition device (also referred as “primary sensor”) and at least one backup acquisition device (also referred as “backup sensor”). The primary acquisition device may include core devices for acquiring information of one or more objects on the traveling path of the vehicle 130. In some embodiments, the core devices may include one or more light detection and ranging devices (LIDARs). The backup acquisition device may provide supplementary information of the one or more objects on the traveling path of the vehicle 130. In some embodiments, the at least one backup acquisition device 520 may include one or more cameras, one or more ultrasonic devices, one or more radars, a vehicle-to-everything communication (V2X), or the like, or any combination thereof.

The processing sub-system 330 may process data/information, and generate control plans for controlling the vehicle 130. The processing sub-system 330 may include a primary processing device and a backup processing device.

The primary processing device may include a sensor fusion, a map processor, and a primary planning and control processor. The sensor fusion may include a plurality of processors to process data obtained from the acquisition devices of the acquisition sub-system 320, and determine features of one or more objects on a traveling path of the vehicle 130. The features associated with one or more objects may include a height, a width, a property, a position, a movement direction, a movement speed, etc. The map processor may generate map-related data. In some embodiments, the map processor may obtain a high definition map from a storage device (e.g., the storage device 140, the DISK 270, etc.), and generate map data by processing the high definition map. The primary planning and control processor may receive the determined features of one or more objects from the sensor fusion and the map-related data from the map processor, and determine a control plan of the vehicle 130 based on the determined features of the objects and/or the map-related data. The control plan of the vehicle 130 may include a traveling route, a braking operation, a steering operation (e.g., a left turn, a right turn), an acceleration operation, or the like, or a combination thereof.

The backup processing device may include a backup planning and control processor. The backup planning and control processor may serve as a backup device of the primary planning and control processor. In some embodiments, the backup planning and control processor may generate a control plan for stopping the vehicle 130 in the case of an emergency, and monitor the primary planning and control processor 650 in real-time.

The control sub-system 340 may control the vehicle through one or more ECUs. The control sub-system 340 may include one or more primary control devices and one or more backup control devices.

The one or more primary control devices may generate control instruction for controlling the vehicle 130 through one or more mechanical or electric components of the vehicle 130 (e.g., an electric motor, a braking pedal, an accelerator pedal, etc.). In some embodiments, the one or more primary control devices may include a powertrain device, a primary braking device, and a primary steering device. The one or more backup control devices may generate control instructions for controlling the vehicle 130 through one or more mechanical or electric components of the vehicle 130 (e.g., an electric motor, a braking pedal, an accelerator pedal, etc.). The one or more backup control devices may serve as a backup device of the one or more primary control devices. For example, the backup control device may start to work when the primary control device has a failure.

The communication sub-system 350 may facilitate a communication between the processing sub-system 330 and the control sub-system 340 and an internal communication between components of the control sub-system 340. The communication sub-system 350 may include a primary gateway and a backup gateway. The one or more control devices (e.g., ECUs) of the control sub-system 340 may be connected with the processing sub-system 330 (e.g., the primary planning and control processor and the backup planning and control processor) through the primary gateway or the backup gateway. The backup gateway may be a backup device of the primary gateway. In such a circumstance, four connecting interfaces including a first interface, a second interface, a third interface, and a fourth interface may be formed. The first interface may connect the primary planning and control processor and the backup planning and control processor to the primary gateway. The second interface may be a backup interface of the first interface. The second interface may connect the primary planning and control processor and the backup planning and control processor to the backup gateway. The third interface may connect the primary gateway to the one or more control devices. The fourth interface may be a backup interface of the third interface, and the fourth interface may connect the backup gateway to the one or more control devices.

The sub-systems of the autonomous driving system 100 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the sub-systems may be combined as a single sub-system, any one of the sub-systems may be divided into two or more sub-systems.

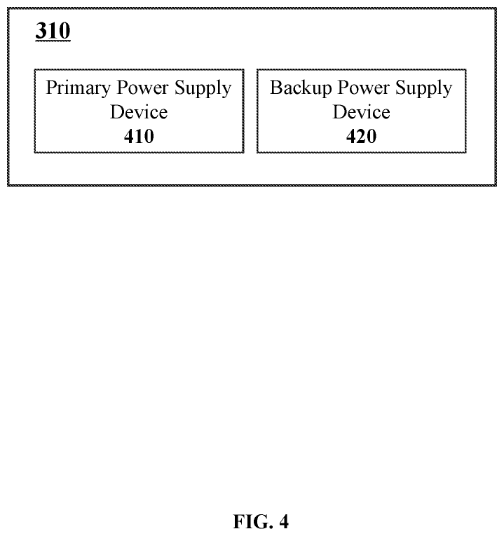

FIG. 4 is block diagram illustrating an exemplary power supply sub-system according to some embodiments of the present disclosure. The power supply sub-system 310 may include a primary power supply device 410 and a backup power supply device 420.

The primary power supply device 410 may be configured to provide electrical power to one or more devices or sub-systems of the autonomous driving system 100. In some embodiments, the primary power supply device 410 may power one or more devices of the acquisition sub-system 320, the processing sub-system 330, and/or the control sub-system 340. For example, the primary power supply device 410 may power at least one primary acquisition device 510 and a first portion of at least one backup acquisition device 520. Merely for illustration purposes, the at least one primary acquisition device 510 may include a group of LIDARs, the first portion of the at least one backup acquisition device 520 may include a first group of cameras and a group pf ultrasonic devices. And the primary power supply device 410 may power the LIDARs, the group of ultrasonic devices, and first group of cameras.

The backup power supply device 420 may be configured to provide electrical power to one or more devices or sub-systems of the autonomous driving system 100. The backup power supply device 420 may be a backup device of the primary power supply device 410 that provides a substitute power supply to the one or more devices or sub-systems of the autonomous driving system 100 when the primary power supply device 410 has a failure (e.g., at a low power). In some embodiments, the backup power supply device 420 may power one or more devices of the acquisition sub-system 320, the processing sub-system 330, and/or the control sub-system 340. For example, the backup power supply device 420 may power the at least one primary acquisition device 510 and a second portion of the at least one backup acquisition device 520. Merely for illustration purposes, the at least one primary acquisition device 510 may include a group of LIDARs, the second portion of the at least one backup acquisition device 520 may include a second group of cameras, a group of radars, and a V2X. And the backup power supply device 420 may power the LIDARs, the second group of cameras, the group of radars, and the V2X. In some embodiments, the at least one backup acquisition device 520 may include two acquisition devices of a same type, the two acquisition devices may be powered by the primary power supply device and the backup power supply device, respectively. For example, if the backup acquisition device 520 includes a first group of cameras and a second group of cameras, the first group of cameras may be powered by the primary power supply device 410, and the second group of cameras may be powered by the backup power supply device 420. In this way, one of the two group of cameras may work even if a power supply device has a failure.

In some embodiments, both the primary power supply device 410 and the backup power supply device 420 may provide electrical power to the processing sub-system 330 and/or the control sub-system 340. Merely by way of example, both the primary power supply device 410 and the backup power supply device 420 may power each device of the processing sub-system 330 and/or the control sub-system 340. For example, control devices of the control sub-system 340 that control autonomous driving (e.g., autonomous steering, autonomous braking, and autonomous accelerating) of the vehicle 130 may be powered by both the primary power supply device 410 and the backup power supply device 420.

In some embodiments, the primary power supply device 410 and/or the backup power supply device 420 may include batteries, such as, a lead acid battery, a lithium battery, a fuel cell battery, etc. In some embodiments, the primary power supply device 410 and/or the backup power supply device 420 may include battery packs with a plurality of batteries. For example, the primary power supply device 410 may include a rechargeable lithium-ion battery pack.

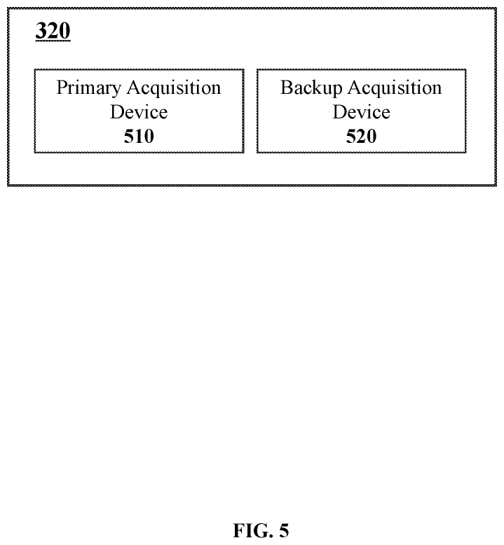

FIG. 5 is block diagram illustrating an exemplary acquisition sub-system according to some embodiments of the present disclosure. The acquisition sub-system 320 may acquire environmental information associated the vehicle 130. The environmental information may include information of one or more objects on a traveling path of the vehicle 130. In some embodiments, the one or more objects may include a vehicle (e.g., a car, a bus, a truck, a motorcycle, a cycle), a pedestrian, an animal, a roadblock, a building, a traffic light, a pedestrian crossing, an intersection, etc. The acquisition sub-system 320 may receive information associated with the one or more objects from a plurality of acquisition devices (e.g., LIDARs, cameras) installed on the vehicle.

In some embodiments, the plurality of acquisition devices may include at least one primary acquisition device 510 and at least one backup acquisition device 520. The primary acquisition device 510 may include core devices for acquiring information of one or more objects on the traveling path of the vehicle 130. In some embodiments, the core devices may include one or more light detection and ranging devices (LIDARs). A LIDAR may determine a distance to a target object by illuminating the target object with pulsed laser light and measuring reflected pulses of the pulsed laser light. In some embodiments, a LIDAR may generate a digital three-dimensional (3D) image of the target object after the LIDAR scans the target object. In some embodiments, the vehicle 130 may be equipped with one or more LIDARs as primary acquisition device 510 so as to acquire distances, positions, and/or sizes of one or more objects on the traveling path of the vehicle 130.

The backup acquisition device 520 may provide supplementary information of the one or more objects on the traveling path of the vehicle 130. In some embodiments, the at least one backup acquisition device 520 may include one or more cameras, one or more ultrasonic devices, one or more radars, a V2X, or the like, or any combination thereof. The cameras may be optical cameras, infrared cameras, or a combination of both. An ultrasonic device may detect a distance and a movement of a target object by emitting ultrasound to a target object and measuring ultrasound reflected by the target object. A radar may work in a similar way as the ultrasonic device except that the radar emits radio waves. The V2X may obtain information from any entity (e.g., vehicles within a certain range of the vehicle 130) that may affect the vehicle, and transmit information from the vehicle to the entity. The V2X may be used in the cases of forward collision warning, lane change warning, road warning, emergency vehicle approaching, or the like. In some embodiments, the backup acquisition device 520 may operate when the primary acquisition device 510 is determined to be malfunctioning or insufficient. In some embodiments, the backup acquisition device 520 may operate as a supplement to the primary acquisition device 510. For instance, under a certain weather condition in which the performance of the primary acquisition device 510 is sub-optimal, the backup acquisition device 520 may operate as a substitute or as a supplement to the primary acquisition device 510.

In some embodiments, the acquisition sub-system 320 may acquire information of objects on a traveling path of the vehicle 130 using one or more acquisition devices of the primary acquisition devices and the backup acquisition devices. Even though a part of the primary acquisition devices and/or the backup acquisition devices have failures, other devices may help the autonomous driving system 100 to obtain sufficient information of the ambient environment.

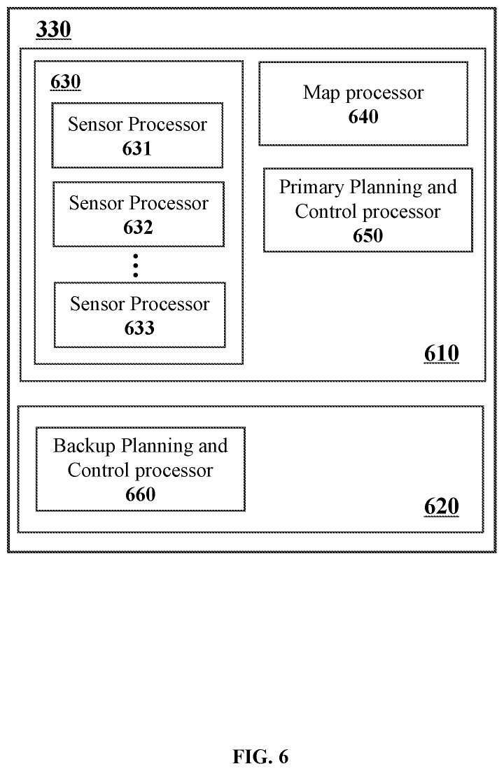

FIG. 6 is block diagram illustrating an exemplary processing sub-system according to some embodiments of the present disclosure. The processing sub-system 330 may include a primary processing device 610 and a backup processing device 620.

The primary processing device 610 may include a sensor fusion 630, a map processor 640, and a primary planning and control processor 650. The sensor fusion 630 may process data obtained from the acquisition devices of the acquisition sub-system 320, and determine features of one or more objects on a traveling path of the vehicle 130. The sensor fusion 630 may include a plurality of sensor processors, for example, sensor processors 631, 632, and 633. The plurality of sensor processors may correspond to acquisition devices of the acquisition sub-system 320. In some embodiments, each acquisition device of the acquisition sub-system 320 may correspond to at least one sensor processor. For example, the sensor fusion 630 may include six sensor processors. The six sensor processors may be electrically connected to a group of LIDARs, a first group of cameras, a second group of cameras, a group of radars, a group of ultrasonic devices, and a V2X, respectively. Each of the six sensor processors may obtain and process data obtained from one type of acquisition devices corresponding to the sensor processor. In some embodiments, the autonomous driving system 100 may merge data processed by the plurality of sensors, and features associated with one or more objects on a traveling path of the vehicle 130 based on the merged data. The features associated with one or more objects may include a height, a width, a property, a position, a movement direction, a movement speed, etc.

The map processor 640 may generate map-related data. In some embodiments, the map processor 640 may obtain location information of the vehicle 130 from a positioning device, such as a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof, and process the obtained location information to determine an accurate location of the vehicle 130 on a map. In some embodiments, the map processor 640 may obtain a high definition map from a storage device (e.g., the storage device 140, the DISK 270, etc.), and generate map data by processing the high definition map.

The primary planning and control processor 650 may receive the determined features of one or more objects from the sensor fusion 630 and the map-related data from the map processor 640, and determine a control plan of the vehicle 130 based on the determined features of the objects and/or the map-related data. The control plan of the vehicle 130 may include a traveling route, a braking operation, a steering operation (e.g., a left turn, a right turn), an acceleration operation, or the like, or a combination thereof. The control plan may be transmitted to the control sub-system 340 to generate control instructions for controlling the vehicle via one or more components of the vehicle.

The backup processing device 620 may include a backup planning and control processor 660. The backup planning and control processor 660 may serve as a backup device of the primary planning and control processor 650. In some embodiments, the backup planning and control processor 660 may generate a control plan for stopping the vehicle 130 in the case of an emergency, and monitor the primary planning and control processor 650 in real-time. Once the primary planning and control processor 650 has a failure (e.g., no response), the backup planning and control processor 660 may receive the determined features of the objects from the sensor fusion 630 and the map-related data from the map processor 640, and determine a control plan of the vehicle based on the determined features of the objects and/or the map-related data. In some embodiments, the processing sub-system 330 including the primary processing device 610 and the backup processing device 620 may be powered by both the primary power supply device 410 and the backup power supply device 420.

It should be noted that the processing sub-system is merely provided for the purposes of illustration, and is not intended to limit the scope of the present disclosure. For persons having ordinary skills in the art, multiple variations or modifications may be made under the teachings of the present disclosure. For example, the backup processing device 620 may further include a sensor fusion and/or a map processor serving as backup devices of the sensor fusion 630 and/or the map processor 640. However, those variations and modifications do not depart from the scope of the present disclosure.

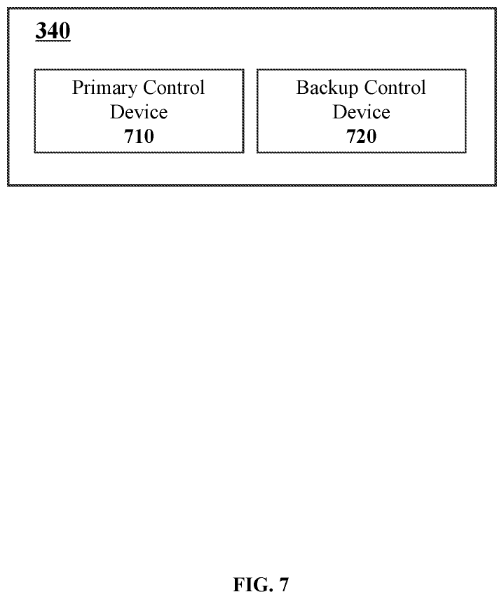

FIG. 7 is block diagram illustrating an exemplary control sub-system according to some embodiments of the present disclosure. The control sub-system 340 may include one or more primary control devices 710 and one or more backup control devices 720.

The one or more primary control devices 710 may generate control instruction for controlling the vehicle 130 through one or more mechanical or electric components of the vehicle 130 (e.g., an electric motor, a braking pedal, an accelerator pedal, etc.). In some embodiments, the one or more primary control devices 710 may include a powertrain device, a primary braking device, and a primary steering device. The powertrain device may be configured to generate power, and deliver the power to wheels of the vehicle 130 so as to control the movement of the vehicle 130. The steering device may be configured to adjust a heading angle and/or a direction of the vehicle 130. The braking device may be configured to perform a braking operation to stop the vehicle 130. In some embodiments, the one or more primary control devices 710 may further include other control devices, such as, an accelerating device, an air conditioning device, a seat heating device, a cabin lighting device, etc. The accelerating device may be configured to control a velocity and/or an acceleration of the vehicle 130.

The one or more backup control devices 720 may generate control instructions for controlling the vehicle 130 through one or more mechanical or electric components of the vehicle 130 (e.g., an electric motor, a braking pedal, an accelerator pedal, etc.). The one or more backup control devices 720 may serve as a backup device of the one or more primary control devices 710. For example, a backup control device 720 may start to work when a primary control device 710 corresponding to the backup control device 720 has a failure.

In some embodiments, each of the one or more primary control devices may have a backup control device serving as a backup device of the primary control device. In some embodiments, each of the one or more primary control devices may have more than one backup control device serving as a backup device of the primary control device. In some embodiments, a part of the one or more primary control devices may be more important, and each of the part of the one or more primary control device may have a backup control device serving as a backup device of the primary control device. For example, the one or more backup control devices 720 may include a backup braking device and a backup steering device serving as backup devices of the primary braking device and the primary steering device, respectively. In some embodiments, the control sub-system 340 including the one or more primary control devices 710 and one or more backup control devices 720 may be powered by both the primary power supply device and the backup power supply device.

It should be noted that the control sub-system is merely provided for the purposes of illustration, and is not intended to limit the scope of the present disclosure. For persons having ordinary skills in the art, multiple variations or modifications may be made under the teachings of the present disclosure. For example, the control sub-system may further include one or more backup control sub-systems. However, those variations and modifications do not depart from the scope of the present disclosure.

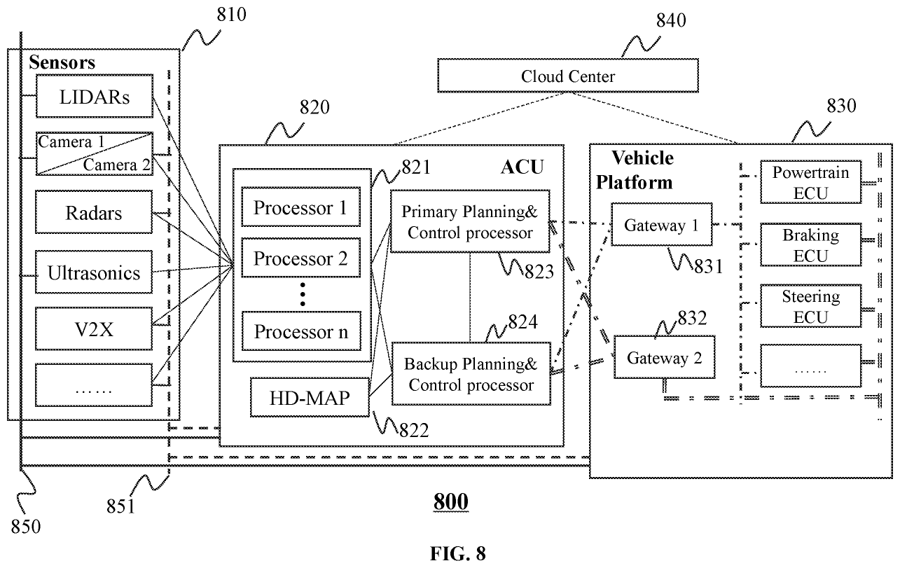

FIG. 8 is a schematic diagram illustrating an exemplary redundancy structure of an autonomous driving system according to some embodiments of the present disclosure. The autonomous driving system 800 may include sensors 810, an arithmetic control unit (ACU) 820, and a vehicle platform 830. The sensors 810, the ACU 820, and the vehicle platform 830 may be installed in an autonomous driving vehicle (e.g., vehicle 130).

The sensors 810 may serve as acquisition devices for acquiring information of objects on a traveling path of the autonomous driving vehicle. The sensors 810 may include a plurality of sensors. The plurality of sensors may include at least one primary sensor and at least one backup sensor. The at least one backup sensor may serve as a backup device of the at least one primary sensor when the at least one primary sensor fails to detect the object on the traveling path of the vehicle (e.g., out of work). Merely by ways of example, the at least one primary sensor may include one or more LIDARs. The at least one backup sensor may include one or more group of cameras (e.g., camera group 1 including one or more cameras and camera group 2 including one or more cameras), one or more radars, one or more ultrasonic devices (e.g., ultrasonic radars), and a V2X. The sensors 810 may be powered through two power lines 850 and 851 represented by a solid bold line and a dashed bold line, respectively. The power line 850 may connect to a primary power supply device. The power line 851 may connect to a backup power supply device. In some embodiments, the primary power supply device and a backup power supply device may be battery packs. The backup power supply device may provide substitute power to one or more sensors when the primary power supply device fails to provide power (e.g., at a low power). The primary power supply device may power the at least one primary sensor and a first portion of the at least one backup sensor. The backup power supply device may power the at least one primary sensor and a second portion of the at least one backup sensor. For example, the primary power supply device may power the one or more LIDARs, the camera group 1, and the one or more ultrasonic devices, and the backup power supply device may power the one or more LIDARs, the camera group 2, the one or more radars, and the V2X.

The ACU 820 may include a sensor fusion 821, a high definition (HD-MAP) processor 822, a primary planning and control processor 823, and a backup planning and control processor 824. The sensor fusion 821 may include a plurality of processors (e.g., processor 1, processor 2, . . . , processor n). In some embodiments, each processor of the sensor fusion 821 may be operably connected to a sensor to obtain information of objects on a traveling path of the vehicle from the sensor, and process the obtained information. In some embodiments, information processed by the plurality of sensors may be merged to determine features of the objects. The HD-MAP processor 822 may generate map-related data. The primary planning and control processor 823 may receive the determined features of the objects and the map-related data from the sensor fusion 821 and the HD-MAP processor 822, respectively, and determine a control plan of the vehicle based on the determined features of the objects and/or the map-related data. The control plan may include a traveling route, a braking operation, a steering operation (e.g., a left turn, a right turn), an acceleration operation, or the like, or a combination thereof. The backup planning and control processor 824 may serve as a backup device of the primary planning and control processor 823. The backup planning and control processor 824 may receive the determined features of the objects and the map-related data from the sensor fusion 821 and the HD-MAP processor 822, respectively, and determine a control plan of the vehicle based on the determined features of the objects and/or the map-related data when the primary planning and control processor 823 fails to determine a control plan of the vehicle. In some embodiments, the ACU 820 may be powered through both the primary power line 850 and the backup power line 851.

The vehicle platform 830 may include a plurality of control devices for controlling the autonomous driving vehicle through one or more mechanical or electric components (e.g., an electric motor, a braking pedal, a steering wheel) of the autonomous driving vehicle (e.g., the vehicle 130). The vehicle platform 830 may obtain the control plan from the primary planning and control processor 823 or the backup planning and control processor 824, and generate control instructions for controlling the autonomous driving vehicle based on the control plan. The plurality of control devices may constitute the control sub-system, which may include one or more primary control devices and one or more backup control devices. In some embodiments, each of the one or more primary control devices may have a backup control device serving as a backup device of the primary control device. In some embodiments, each of the one or more primary control devices may have more than one backup control device serving as a backup device of the primary control device. In some embodiments, a part of the one or more primary control devices may be more important, and each of the part of the one or more primary control device may have a backup control device serving as a backup device of the primary control device. Merely for illustration purposes, the one or more primary control devices may include a powertrain electronic control unit (ECU), a primary braking ECU, and a primary steering ECU. The vehicle platform 830 may further include a backup braking ECU and a backup steering ECU serving as backup devices of the primary braking ECU and the primary steering ECU, respectively.

The vehicle platform 830 may connect with the primary planning and control processor 823 and the backup planning and control processor 824 through a primary gateway 831 or a backup gateway 832. The backup gateway 832 may be a backup device of the primary gateway 831. In such a circumstance, four connecting interfaces including a first interface, a second interface, a third interface, and a fourth interface may be formed. The first interface, represented by a dot-dashed line, may connect the primary planning and control processor 823 and the backup planning and control processor 824 to the primary gateway 831. The second interface, represented by a double-dot-dashed line, may be a backup interface of the first interface. The second interface may connect the primary planning and control processor 823 and the backup planning and control processor 824 to the backup gateway 832. The third interface, represented by a dot-dashed line, may connect the primary gateway 831 to the one or more control devices. The fourth interface, represented by a double-dot-dashed line, may be a backup interface of the third interface, and the fourth interface may connect the backup gateway 832 to the one or more control devices. In some embodiments, a control plan generated by the primary planning and control processor 823 or the backup planning and control processor 824 may pass through the primary gateway 831 via the first interface, and transmitted to the control sub-system via the third interface. In some embodiments, a control plan generated by the primary planning and control processor 823 or the backup planning and control processor 824 may pass through the backup gateway 832 via the second interface, and transmitted to the control sub-system via the fourth interface when the primary gateway 831 fails to obtain and/or transmit the control plan to the control sub-system. The vehicle platform 830 may be powered through both the primary power line 850 and the backup power line 851.

In some embodiments, the ACU 820 and/or the vehicle platform 830 may connect to a cloud center 840. The cloud center 840 may provide data/information to the ACU 820 and/or the vehicle platform 830. The provided data/information may be used to process information of objects acquired from the sensors 810, determine features of the object, generate map-related data, and generate control instructions. In some embodiments, the provided data/information may include parameters, values, algorithms, program codes, models, images, or the like, or a combination thereof. For example, the cloud center may provide an HD map for the primary planning and control processor 823 to plan a route of the vehicle.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system comprising:
an acquisition sub-system including at least one primary acquisition device and at least one backup acquisition device;
a power supply sub-system including:
a primary power supply device configured to power the at least one primary acquisition device and a first portion of the at least one backup acquisition device; and
a backup power supply device configured to power the at least one primary acquisition device and a second portion of the at least one backup acquisition device; and
a processing sub-system connecting the acquisition sub-system, the processing sub-system including:
a primary processing device powered by both the primary power supply device and the backup power supply device; and
a backup processing device that serves as a backup device of at least a part of the primary processing device, the backup processing device being powered by both the primary power supply device and the backup power supply device.

2. The system of claim 1, further including:
a control sub-system including:
one or more primary control devices; and
one or more backup control devices, each of the one or more primary control devices having at least one of the one or more backup control device serving as a backup device of the primary control device.

3. The system of claim 2, the primary control devices including a powertrain device, a primary braking device, and a primary steering device, and the backup control devices including a backup braking device and a backup steering device.

4. The system of claim 2, the control sub-system being powered by both the primary power supply device and the backup power supply device.

5. The system of claim 2, further including:
a primary gateway connecting the primary processing device and the backup processing device with the control sub-system; and
a backup gateway connecting the primary processing device and the backup processing device with the control sub-system.

6. The system of claim 5, further including:
a communication sub-system including:
a first interface connecting the primary processing device and the backup processing device to the primary gateway; and
a second interface being a backup interface of the first interface, the second interface connecting the primary processing device and the backup processing device to the backup gateway.

7. The system of claim 6, further including:
a third interface connecting the primary gateway with the control sub-system; and
a fourth interface being a backup interface of the third interface, the fourth interface connecting the backup gateway with the control sub-system.

8. The system of claim 1, the system being an autonomous driving system.

9. The system of claim 8, the at least one primary acquisition device including a LIDAR, and the at least one backup acquisition device including a camera, a radar, an ultrasonic radar, or a vehicle-to everything (V2X).

10. The system of claim 9, the at least one backup acquisition device including two sensors of a same type, the two sensors being powered by the primary power supply device and the backup power supply device, respectively.

11. The system of claim 9, the primary processing device including a plurality of sensor processors and a primary planning and control processor, and the backup processing device including a backup planning and control processor, the backup planning and control processor being a backup device of the primary planning and control processor.

12. The system of claim 1, the primary power supply device and the backup power supply device including batteries independent to each other.
